(19) United States
(12) Patent Application Publication
(10) Pub. No.: US 2014/0011969 A1
(43) Pub. Date: Jan. 9, 2014

(54) METHODS FOR FABRICATING POLYMER COMPOSITES

(71) Applicant: University of Louisville Research Foundation, Inc., (US)

(72) Inventor: Balaji Panchapakesan, Louisville, KY (US)

(73) Assignee: UNIVERSITY OF LOUISVILLE RESEARCH FOUNDATION, INC., Louisville, KY (US)

(21) Appl. No.: 13/889,121

(22) Filed: May 7, 2013

Related U.S. Application Data
(60) Provisional application No. 61/643,440, filed on May 7, 2012.

(51) Int. Cl. C08K 3/04

(52) U.S. Cl. CPC C08K 3/04
USPC 525/476; 525/474

(57) ABSTRACT

A method for fabricating a polymer composite is provided that includes providing a mixture of carbon nanostructures and a polymeric material, and then photo-thermally heating the mixture to cross-link the carbon nanostructures and the polymeric material. The carbon nanostructures can be carbon nanotubes, buckyballs, graphene, or the like, and the mixture can include about 0.01 to about 1.0 percent by weight of the carbon nanostructures. Polymer composited produce by the fabrication methods are also provided.

### RELATED APPLICATIONS

This application claims priority from U.S. Provisional Application Ser. No. 61/643,440, filed May 7, 2012, the entire disclosure of which is incorporated herein by this reference.

### GOVERNMENT INTEREST

This invention was made with government support under CAREER Award No. 0853066 awarded by the National Science Foundation. The government has certain rights in the invention.

### TECHNICAL FIELD

The present invention relates to methods for fabricating polymer composites. In particular, the present invention relates to methods for fabricating polymer composites whereby a mixture of carbon nanostructures and polymeric materials are photo-thermally heated to cross-link the carbon nanostructures and the polymeric materials and thereby form the polymer composite.

### BACKGROUND

One of the applications of carbon nanostructures, such as carbon nanotubes, is as nano-scale fillers to improve the mechanical properties of polymeric materials. Indeed, the high aspect ratio, elastic modulus, and tensile strength of carbon nanotubes have allowed carbon nanotubes to be used as nanoscale fillers and to enable load transfer and improvements in the mechanical strength of polymer nanocomposites. In using carbon nanotubes as nanoscale fillers, however, the nanotube/polymer interface has been observed to play an important role in the efficient stress transfer to the nanotube and in the overall mechanical properties of the nanotube-polymeric composite [1]. For example, in the examination of a multi-wall carbon nanotube (MWNT)/epoxy system using Raman spectroscopy, an enhanced shift in Raman G′ mode was observed during compression of the system that demonstrated higher interfacial shear stress and load transfer to the nanotube [2]. Numerous reports have also demonstrated an enhanced load transfer to the nanotubes through strategies including surface functionalization of nanotubes [3-5], refluxing CNTs with nitric acid to create carboxyl, carbonyl, and hydroxyl groups [6,7], side wall functionalization for better dispersion of nanotubes in the matrix [8] and alignment of nanotubes in the matrix [9], in-situ melting and polymerization [10,11], melt compounding [12], and, more recently, the use of flexible spacers at the nanotube-polymer interface [13].

Despite the initial favorable results observed in using carbon nanostructures as nano-scale fillers, however, few improvements have been made to the process to date that allow for further increases in the strengthening of the nanotube-polymer interface. Current oven-based convection heating methods for cross-linking the carbon nanostructures have only allowed heat to flow through the carbon nanostructure/polymer mixture from the outside to the inside, and thus, convection heating has been unable to enhance the cross-linking in the interior of the mixture or at the site of the nanostructure/polymer interface.

### SUMMARY

The present invention includes methods for fabricating polymer composites and polymer composites that make use of or include carbon nanostructures and a polymeric material.

In one exemplary implementation, a method is provided for fabricating a polymer composite that comprises the steps of providing a mixture including carbon nanostructures and a polymeric material, and then photo-thermally heating the mixture to thereby cross-link the carbon nanostructures and the polymeric material. In some implementations, the method is performed such that the step of photo-thermally heating the mixture includes heating the mixture from an interface of the carbon nanostructures and the polymeric material to an exterior surface of the mixture.

In some implementations, the step of photo-thermally heating the mixture includes exposing the mixture to electromagnetic radiation. In certain embodiments the electromagnetic radiation is near infrared radiation, and the near infrared radiation can include wavelengths of about 650 nm to about 1400 nm. In certain exemplary implementations, the mixture can be exposed to electromagnetic radiation (e.g., near infrared radiation) for about 20 minutes to about 240 minutes.

The carbon nanostructures utilized in certain embodied methods can be selected from the group consisting of carbon nanotubes, buckyballs, graphene, or the like, or combinations thereof. In particular embodiments, the carbon nanostructures can include multi-wall carbon nanotubes. In further embodiments that comprise graphene carbon nanostructures, the graphene can comprise reduced graphene oxide, graphene nanoplatelets, or combinations thereof. In this regard, exemplary methods can utilize mixtures that include about 0.01 to about 1 percent by weight of the carbon nano structures.

Further still, the polymeric material utilized in exemplary methods can be selected from a plastic material or a rubber material. In certain embodiments, the polymeric material is polydimethyl siloxane.

Exemplary methods can further comprise a step of adding one or more cross-linking agents to the mixture prior to photo-thermally heating the mixture, optionally so as to achieve a ratio of the cross-linking agents to the polymeric material of about 1:10. Exemplary methods can also further comprise a step of degassing the mixture prior to photo-thermally heating the mixture. Still further, in some embodiments, the step of providing a mixture includes mixing the mixture of carbon nanotubes and the polymeric material for about 5 minutes to about 160 hours before photo-thermally heating the mixture.

In certain embodiments, a method for fabricating a polymer composite is provided that comprises mixing carbon nanostructures and a polymeric material to form a mixture, and exposing the mixture to near infrared radiation to photo-thermally heat the mixture and thereby cross-link the carbon nanostructures and the polymeric material into a polymer composite. In such embodiments, the near infrared radiation can include radiation that includes wavelengths of about 650 nm to about 1400 nm.

Further, in some embodiments of the present invention, a polymer composite is provided that is fabricated by a process comprising the steps of providing a mixture including carbon nanostructures and a polymeric material, and photo-thermally heating the mixture to thereby cross-link the carbon nanostructures and the polymeric material. Such polymer composites can, in some embodiments, comprise an elastic modulus of 0.5 MPa to about 1 GPa. Furthermore, and as mentioned above, the carbon nanostructures can be carbon nanotubes, buckyballs, graphene, including reduced graphene oxide or graphene nanoplatelets, or combinations thereof. Furthermore, embodiments of the polymer composite can include about 0.01 to about 1 percent by weight of the carbon nanostructures.

Further features and advantages of the present invention will become evident to those of ordinary skill in the art after a study of the description, figures, and non-limiting examples in this document.

### BRIEF DESCRIPTION OF THE DRAWINGS

FIG. 1 includes schematic diagrams showing two different types of polymerization techniques, namely convective oven based heating (panel (a)) and near infrared (NIR) light heating (panel (b)) in accordance with the methods of the present invention;

FIG. 2 includes scanning electron microscopy (SEM) images of multi-walled carbon nanotube/polydimethyl siloxane (MWNT/PDMS) samples that were prepared using 0.01 wt % (panel (a)), 0.1 wt % (panel (b)), and 1 wt % (panel (c)) MWNT fractions (scale bar: 500 nm), and further includes a graph showing Raman spectra of pure PDMS and a 1 wt % MWNT/PDMS sample (panel (d));

FIG. 3 includes graphs showing load transfer in conventional (panel (a-1)) and NIR light treated methods (panel (b-1)), and showing a change in wavenumber as a function of percentage strain for conventional (panel (a-2)) and NIR light polymerized samples (panel (b-2));

FIG. 4 includes graphs showing Young's modulus versus NIR light dose for MWNT/PDMS fractions (panel (a)), and showing the change in elastic modulus versus the weight percentage of MWNT for light treated and oven baked methods (panel (b));

FIG. 5 includes SEM images of a graphene nano platelet (GNP) sample (panel (a-1)), a GNP/PDMS sample (panel (a-2)), a reduced graphene oxide (RGO) sample (panel (b-1)), and a RGO/PDMS sample (panel (b-2));

FIG. 6 includes SEM images of a fracture surface of a GNP/PDMS sample showing collapsed GNPs on the crater of a micro-crack (panel (a-1)) and collapsed GNPs aiding in load transfer (panel (a-2)), and showing a fracture surface of a RGO/PDMS sample showing RGO between crack openings (panel (b-1)) and showing cracking of the RGO after the PDMS peels (panel (b-2));

FIG. 7 includes graphs showing Raman spectra of the D band (panel (a)), G band (panel (b)), and 2D (panel (c)) band for GNP, RGO, a GNP/PDMS sample, and a RGO/PDMS sample; and further includes graphs showing IG/ID versus shear mixing time (panel (d)) and showing IG/I2D versus shear mixing time (panel (e));

FIG. 8 includes graphs showing load transfer of GNP (panel (a-1)) and RGO (panel (b-1)), and showing a change in wavenumber as a function of percentage strain for a GNP/PDMS sample (panel (a-2)) and a RGO/PDMS sample (panel (b-2));

FIG. 9 includes graphs showing the full width half maximum (FWHM) of wavenumber as a function of percentage strain for a GNP/PDMS sample (panel (a)) and a RGO/PDMS sample (panel (b)) prepared by conventional baking (square) and a NIR light method (triangle);

FIG. 10 includes graphs showing cyclic stress strain curves (panel (a-1)) and stress-strain curves (panel (a-2)) until fracture for pure PDMS, a RGO/PDMS sample, and a GNP/PDMS sample prepared by conventional baking, and showing cyclic stress strain curves (panel (b-1)) and stress-strain curves (panel (b-2)) until fracture for pure PDMS, a RGO/PDMS sample, and a GNP/PDMS sample prepared by a NIR light method;

FIG. 11 includes graphs showing Young's modulus versus NIR light dose for a RGO/PDMS sample and a GNP/PDMS sample (panel (a)), and showing change in elastic modulus versus weight percentage of RGO or GNP for light treated samples (panel (b));

FIG. 12 includes a graph of power as a function of wavelength and showing the spectrum profile of a halogen lamp with a UV filter;

FIG. 13 includes graphs showing the XPS spectra of GNP (panel (a-1)), RGO (panel (b-1)), and MWNT (panel (c-1)), graphs showing C1s binding energies of GNP (panel (a-2)), RGO (panel (b-2)), and MWNT (panel (c-2)), and graphs showing O1s binding energies of GNP (panel (a-3)), RGO (panel (b-3)), and MWNT (panel (c-3));

FIG. 14 includes graphs showing XPS peaks for a MSNT/PDMS sample prepared by conventional baking of O1s (panel (a-1)), C1s (panel (a-1)), and Si2p (panel (c-1)), and showing XPS peaks for a MSNT/PDMS sample prepared by a NIR light method of O1s (panel (b-1)), C1s (panel (b-2)), and Si2p (panel (c-2));

FIG. 15 includes graphs showing XPS peaks for a RGO/PDMS sample prepared by conventional baking of O1s (panel (a-1)), C1s (panel (a-1)), and Si2p (panel (c-1)), and showing XPS peaks for a RGO/PDMS sample prepared by a NIR light method of O1s (panel (b-1)), C1s (panel (b-2)), and Si2p (panel (c-2)); and

FIG. 16 includes chemical structures showing the PDMS oligomer and the PDMS linker (panel (a-1)), and showing the reaction model of conventional baking polymerization (panel (a-2)) and NIR photon-assisted polymerization (panel (a-3)).

### DESCRIPTION OF EXEMPLARY EMBODIMENTS

The present invention relates to methods for fabricating polymer composites whereby a mixture of carbon nanostructures and polymeric materials are photo-thermally heated to cross-link the carbon nanostructures and the polymeric materials and thereby form the polymer composite.

It has been observed that the irradiation of mixtures of carbon nanostructures and polymeric materials using infra-red photons during cross-linking results in the heating of the nanotubes in the interior of the polymeric mixture, and thereby enables the cross-linking of the carbon nanotubes to begin at the nanotube-polymer interface. Further, by photo-thermally heating the mixture from the inside, it has been observed that enhanced cross-linking occurs, which further strengthens the nanostructure-polymer interface and allows for polymerization and strengthening that would not otherwise be possible using oven-based convective heating methods, where heat flows through the sample from outside to the inside.

In one exemplary implementation of a method for fabricating a polymer composite in accordance with the present invention, an amount of carbon nanostructures is first provided and is mixed with an amount of a polymeric material. As used herein, the term “carbon nanostructures” is used to refer to carbon-based structures having at least one dimension with a size smaller than about 1000 nanometers. Such carbon nanostructures are known to those of ordinary skill in the art and include, but are not limited to, carbon nanostructures comprised of clusters of carbon atoms and carbon nanostructures comprised of carbon atoms arranged in various geometrical configurations. For example, in some implementations, the carbon nanostructures are selected from carbon nanotubes (e.g., single-wall carbon nanotubes or multi-wall carbon nanotubes), buckyballs, graphene, graphene nanoplatelets, and the like. In some implementations, the carbon nanotubes are multi-wall carbon nanotubes. In some implementations, the carbon nanostructures can be comprised of any carbon-based materials capable of absorbing infra-red energy and converting the energy to heat at the nano-meter to micro-meter length scale.

In this regard, graphene generally is a 2D sheet compared to nanotubes that are quasi-1D. The thermal conductivity of graphene is typically higher than that of carbon nanotubes, and phonon heat transfer can occur in both dimensions of the sheet. Furthermore, mixing graphene sheets in polymers can result in the edges of the graphene sheet being functionalized thereby resulting in greater dispersion, enhanced stiffness, shorter polymer chain lengths and better mechanical properties.

With respect to the polymeric materials used in accordance with the methods of the present invention, in some implementations, the polymeric material is comprised of a plastic material, a rubber material, or combinations thereof. Exemplary polymers capable of use in accordance with the presently-disclosed methods include, but are not limited to, polymers comprised of thermo-plastics or thermo-setting plastics, as well as conventional polymers, such as polypropylene, polyisobutylene, poly methyl methacrylate, poly vinyl acetate, poly vinyl methyl ether, polybutadiene, polyisoperene, poly vinyl chloride, poly vinyl alcohol, poly vinyledene chloride, poly vinyledene fluoride, poly tetrafluoroethylene, poly acrylonitrile, polyoxymethylene, polyethyleneoxide, poly hexamethylene adipamide, poly caprolactan, polymethylstyrene, polyphenyloxide, polycaprolactone, poly L-lactic acid, poly-theylene terephthalate, polycarbonate, polyetheretherketone, polysulfone, polyimide, polyp-phenylene terephthalamide (Kevlar), polydimethylsiloxane, and polytetramethyl-p-silphenylene siloxane. In some implementations, the polymeric material is polydimethyl siloxane. Of course, any other polymeric material capable of being combined with a carbon nanostructure to create a polymer composite can also be used without departing from the spirit and scope of the present invention.

The carbon nanostructures that are combined with the polymeric materials to form the mixture are generally added in an amount sufficient to suitably enhance the cross-linking of the carbon nanostructure/polymeric interface and to provide a requisite degree of load transfer and requisite improvement in the mechanical properties of the resulting polymer composite. In this regard, in many cases, specific amounts of carbon nanostructures added to a polymeric material will depend, at least in part, on the mechanical properties desired for a particular application. In some implementations of the present invention, the mixture includes about 0.01 percent to about 1 percent by weight of the carbon nanostructures.

In some implementations of the methods of the present invention, the mixing of the carbon nanostructures with the polymeric materials is performed in a manner that provides a homogenous dispersion of the carbon nanostructures in the polymeric materials to thereby assist in the cross-linking of the carbon nanostructures with the polymeric materials. For example, in some embodiments, the carbon nanostructures are mixed within the polymeric materials by first sonicating the carbon nanostructures in a suitable solvent and then evaporatively mixing the polymeric material with the carbon nanostructures (see, e.g., Loomis, et al. Applied Physics Letters, vol. 100, 2012, which is incorporated herein by reference in its entirety). In some implementations, the mixture of polymeric materials and carbon nanostructures is mixed for about 5 minutes to about 160 hours.

In some implementations, to further assist in the cross-linking of the carbon nanostructures, one or more cross-linking agents are added to the mixture prior to photo-thermally heating the mixture in an amount recommended for a particular manufacturing specification based on the polymeric material or the particular application. In some implementations, the cross-linking agents are added to the mixture in a ratio of cross-linking agent to polymeric material of about 1:10. In some implementations, the mixture is also degassed prior to photo-thermal heating.

Regardless of the particular process used to mix the desired amount of carbon nanostructures with a polymeric material, once the carbon nanostructure/polymeric material mixture has been created, the mixture is then photo-thermally heated to cross-link the carbon nanostructures and the polymeric material from the interior of the mixture to the outside, such that enhanced cross-linking and strengthening occurs relative to conventional processes that make use of convection ovens to heat the mixture from the outside of the mixture to its interior.

In some implementations, the mixture of carbon nanostructures and polymeric material can be photo-thermally heat by exposing the mixture to electromagnetic radiation. Different implementations can utilize different forms of electromagnetic radiation to photo-thermally heat the mixtures. For example, different implementations can utilize electromagnetic radiation ranging from x-rays to radio waves and any radiation falling therebetween along the electromagnetic spectrum. Thus, in some implementations, the electromagnetic radiation utilized can have wavelengths of about 10⁻¹² to about 1000 m.

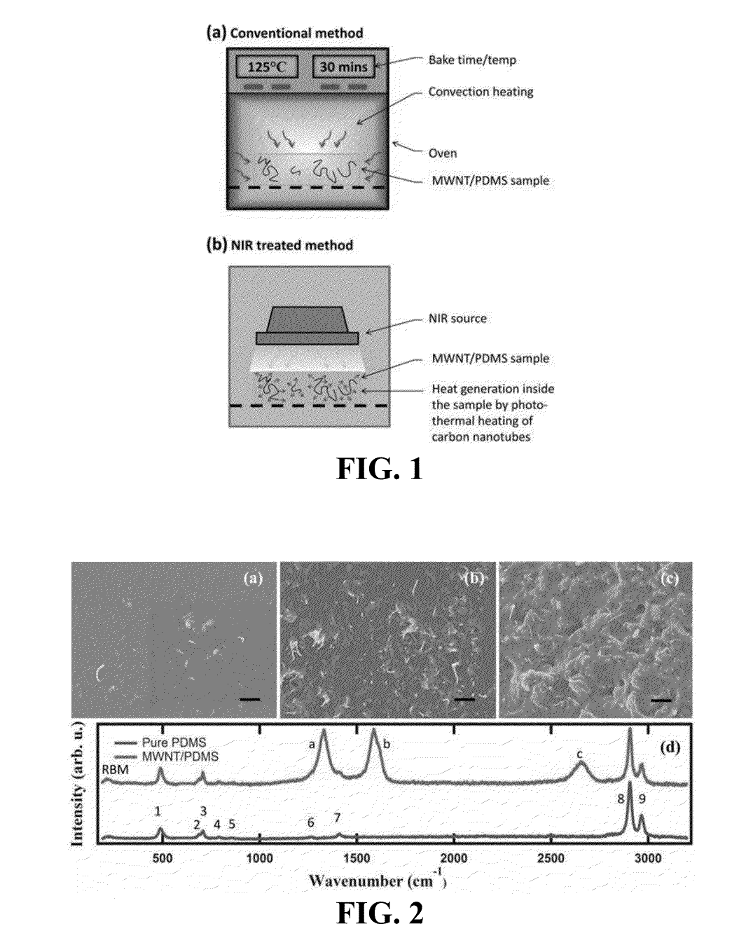

In some implementations, and as shown in FIG. 1(b), the step of photo-thermally heating the mixture comprises exposing the mixture to near-infrared (NIR) radiation. For example, in some implementations, the mixtures can be exposed to NIR radiation using a NIR lamp that is placed on top of the sample and used to irradiate the mixtures for about 20 to about 240 minutes such that the carbon nanostructures are able to absorb the light and be heated, thereby cross-linking the polymer around the nanotubes. In some implementations, the near infrared radiation utilized has wavelengths of about 650 nm to about 1400 nm. Of course, the sources of photo-thermal heat can also include other devices that emit NIR light, such as regular lamps, ovens, and the like.

Further provided, in some embodiments of the present invention, are polymer composites produced by the foregoing methods. In some embodiments of the present invention, a polymer composite is provided that is fabricated by a process comprising the steps of providing a mixture including carbon nanostructures and a polymeric material, and photo-thermally heating the mixture to thereby cross-link the carbon nanostructures and the polymeric material. Such polymer composites can, in some embodiments, comprise an elastic modulus of about 0.5 MPa to about 1 GPa, and certain embodiments comprise an elastic modulus of about 1.65 MPa to about 2.33 MPa. Furthermore, and as mentioned above, the carbon nanostructures can be carbon nanotubes, buckyballs, graphene, including reduced graphene oxide or graphene nanoplatelets, or combinations thereof. Furthermore, embodiments of the polymer composite can include about 0.01 to about 1 percent by weight of the carbon nanostructures.

The above-described methods of fabricating a polymer composite, which allow for the heating and cross-linking of carbon nanostructures and polymeric materials from the interior of a mixture, are important for enabling the large scale cross-linking and the enhancement of the mechanical properties of nano-composite materials in general. For instance, the present method can be useful in improving the interfacial shear strength and mechanical properties of emerging classes of light weight and high strength nano-composites that are based on graphene, improvements that may not otherwise be able to be achieved by surface chemical functionalization of nanotubes/graphene mixtures as recent reports have shown that surface functionalization of nanotubes does not always promote a substantial improvement in the mechanical properties of resulting composites as a result of surface degradation of the nanotubes/graphene during functionalization. Further, the use of photo-thermal heat treatments, such as NIR light, is benign and can render high strength nano-composites, thus making the methods suitable for treating nanotubes/graphene functionalized with sulfur and for enabling the nano- to macroscopic scale vulcanization of rubber materials that are of significant use in many day-to-day applications.

Accordingly, some of the superior results of polymer composites made in accordance with the present invention by NIR polymerization of carbon nanostructure composites include: 1) the carbon nanostructures participate in the polymerization process simultaneously by absorbing photons and converting them into heat, 2) rapid stiffening of the polymeric composites due to the entire sample being heated at the nano-scale simultaneously, 3) shorter segmental chain length resulting in higher stiffness and better values for Young's modulus, 4) the ability to tune the polymerization process and stiffness of a polymeric composite by regulating NIR dosage, and 5) the ability to create selective regions with dynamically tunable stiffness in polymeric materials (e.g., polymers, rubbers, gels).

The presently-disclosed subject matter is further illustrated by the following specific but non-limiting examples.

### EXAMPLES

### Example 1

To examine the properties of polymer composite materials fabricated in accordance with the methods of the present invention, homogenous dispersions of multi-wall carbon nanotubes (MWNT) in polydimethyl siloxane (PDMS) were first prepared using an evaporative mixing process developed recently using a combination of sonication of MWNT in isopropyl alcohol (IPA) for 4 hours, evaporative mixing of PDMS base compound with the MWNT-IPA suspension for 24 hours at 65° C., addition of cross linkers (base compound:curing agent ratio is 10:1) and subsequent degas procedures, cross-linking and polymerization, spin coating and baking and finally post-bake relaxation for approximately 12 hours [19]. For control purposes, certain samples were prepared using a conventional process, where the samples were heated in a convective vacuum oven at approximately 125° C. for approximately 30 minutes following the addition of cross-linkers and the degas procedure (FIG. 1(a)). For samples prepared with NIR light treatment according to the presently-described methods, the samples were exposed to NIR radiation following addition of the cross-linkers and degas procedures for varying levels of light power, as shown in FIG. 1(b).

Subsequent to fabricating the polymer composites, the load transfer and elastic modulus of NIR light polymerized samples were then compared with samples prepared by the conventional oven polymerized methods. Scanning electron microscopy was used to investigate sample cross-sections and nanotube-polymer interface, and Raman spectroscopy was used to ascertain the shift in the wavenumbers with increasing strains to compare the load transfer between conventional baking and NIR light treated procedures. In this regard, the 632.8 nm line beam of a helium-neon laser in an in Via RENISHAW® micro-Raman spectrometer (Gloucestershire, United Kingdom) was focused onto the sample surface through a ×50 objective lens, forming a laser spot approximately 3 μm in diameter. Strains were then applied to the sample under the micro-Raman spectrometer by stretching the sample to a pre-determined length using a linear actuator. Finally, samples containing various fractions (0.01-1 wt %) of MWNT in PDMS were also prepared and tested for their elastic modulus using both convective oven heated and NIR photon irradiated samples. The Young's modulus of the sample was measured by measuring the stress change with application of a pre-strain to the samples from 0-5% with increase in pre-strain of 1% [20]. The effect of improvement in elastic modulus for different weight fractions of MWNT and different levels of infra-red radiation were also studied.

FIG. 2(a) presents the cross-sectional scanning electron micrograph (SEM) of the nanotube polymer interface for various weight fractions of MWNT (0.01-1 wt %) in PDMS. Raman spectra for both pure PDMS and MWNT/PDMS composites are presented in FIG. 2(b). SEM images show clear dispersion of MWNT with increasing nanotube density with increasing wt % of the samples. In all three SEM images, one end of the MWNT was stretched out of the matrix while the other end was embedded firmly in the matrix, which is indicative of strong interfacial adhesion between the nanotube and PDMS polymer [12]. The SEM images of both convective oven heated samples and the NIR photon irradiated samples qualitatively exhibited similar results. In the Raman spectrograph of FIG. 2(b), all the nine peaks associated with the PDMS can be seen in both of the samples. The radial breathing mode (RBM, 219.3 cm⁻¹), the disorder induced D band (1328 cm⁻¹) tangential mode G band (1588 cm⁻¹) and 2D or G′ (2657 cm⁻¹) bands of the MWNT are seen in the nanotube/polymer sample demonstrating high purity of sample preparation and subsequent cross-linking and polymerization methods. Based on the RBM mode of the nanotube/polymer sample, the diameter of the nanotube was calculated using the equation: ω_{RBM}=A/dₜ+B, where A=233 cm⁻¹ nm and B=10 cm⁻¹ are constants, which gave an inner diameter of MWNT approximately 1.06 nm. This diameter values based on the RBM mode in the nanotube/polymer samples demonstrated lack of bundling of the MWNT and excellent dispersion of the MWNT in the polymer samples using the evaporative mixing process. The lack of bundling and smaller diameter can also indicate higher interaction of the nanotube with the polymer providing better interfacial adhesion and strength for both the methods.

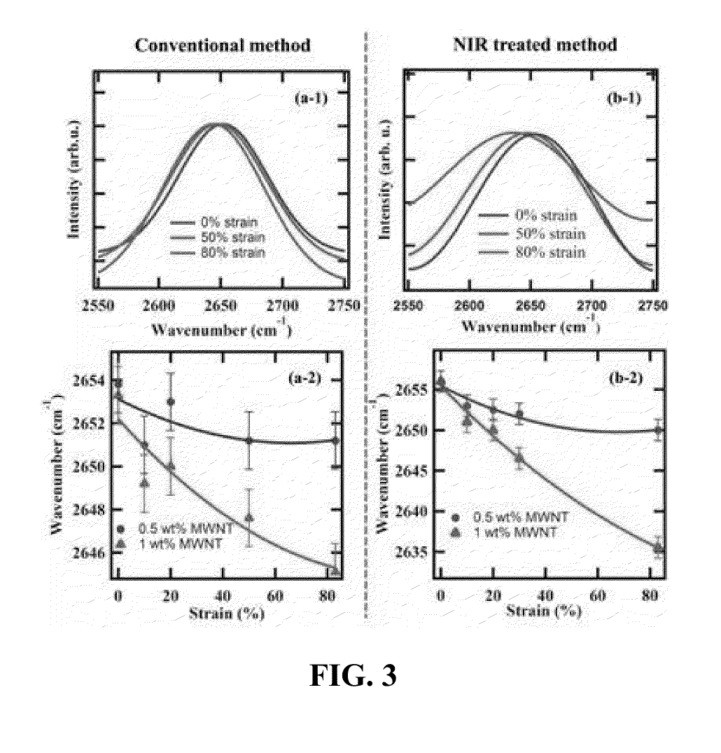

Raman spectroscopy has previously been used by others to measure strains in nanoscale fillers such as carbon nanotubes [2, 21-28]. When a strain is applied, the interatomic distances change resulting in shifts in the vibrational frequencies. The G′ band at approximately 2700 cm⁻¹ in the Raman spectra for MWNT is highly sensitive to strain. The larger shift in Raman peak position of the G′ band is indicative of larger load carried by the nanotubes. Since the SEM images and the Raman signatures of the samples look qualitatively similar before applying strain, characterizing the wavenumber shift in G′ peak in both the samples would thus indicate the strength of the nanotube-polymer interface for both the samples. FIG. 3 presents the shift in the Raman peak position of the G′ band for both oven polymerized (FIG. 3(a-1)) and NIR light polymerized samples (FIG. 3(b-1)) as a function of applied tensile strain. It was clear from these experiments that the oven polymerized samples have smaller shift to the left in the Raman peak position compared to the NIR light treated samples. Additionally, there are several interesting characteristics in the Raman spectra as a function of applied strains. For both the conventional and NIR photon irradiated methods, at 0% strain, the Raman signatures look identical (blue line). As the strain was increased to approximately 50%, however, the oven baked samples underwent only a small shift to the left (FIG. 3 (a-1)), while the NIR light treated method underwent a much larger shift (FIG. 3 (b-1)). The shift in Raman peak position at approximately 80% strain was even more predominant for the NIR photon polymerized samples. As such, it was clear from FIGS. 3(a-1) and 3(b-1), that the higher load transfer to the nanotube occurred in the samples treated with NIR light compared to convective oven polymerized samples, which is indicative of better cross-linking and polymerization of the nanotube/polymer interface.

FIGS. 3(a-2) and 3(b-2) presents the change in wavenumbers as a function of strain. For both oven baked samples and NIR light treated samples, there was a decrease in G′ mode wavenumbers for 0.5 wt % and 1 wt % MWNT/polymer samples. For the oven baked method, there was 3 cm⁻¹ change in wavenumber for 0.5 wt % and 9 cm⁻¹ change in wavenumber for 1 wt % MWNT/polymer composites for the strain values tested. On the other hand, there was 5 cm⁻¹ change in wavenumber for 0.5 wt % and 20 cm⁻¹ change in wavenumber for 1 wt % MWNT/polymer composites for the NIR light treated method for the strains from 0-80%. Samples strained greater than 80% lead to complete failure. Past reports on the use of Raman spectroscopy for investigating load transfer on nanotube/polymer composites had only been done in a limited range of ±15% strains before failure [2, 29, 30], and thus, the higher strains used in the foregoing experiments and the larger shift in the Raman positions (up to ˜20 cm⁻¹ wavenumbers) showed greater load transfer to the nanotube than reported in the past. It should be noted that for approximately 0.5 wt % MWNT/polymer samples, the wavenumber shift saturated beyond approximately 40% and there was no appreciable change in wavenumbers at 80% strain and the strains were not resolvable beyond approximately 40%. This was true for both the types of samples, which indicated that the saturation of the Raman signal was related to the weight fraction of the nanotube in the polymer matrix or the number of nanotube-polymer sites that underwent strain. Moreover, as the wt % of nanotube increased in the matrix, there was a significant increase in load sharing and samples below and above the percolation threshold (PT) should exhibit different Raman shifts. From past experience, the PT values of nanotube/PDMS samples is approximately 0.5 wt % [19]. Therefore, at 1 wt % or above the PT, the load was shared more uniformly and the interpenetrating network of nanotube in the polymer matrix made the wavenumber shift resolvable at higher strains.

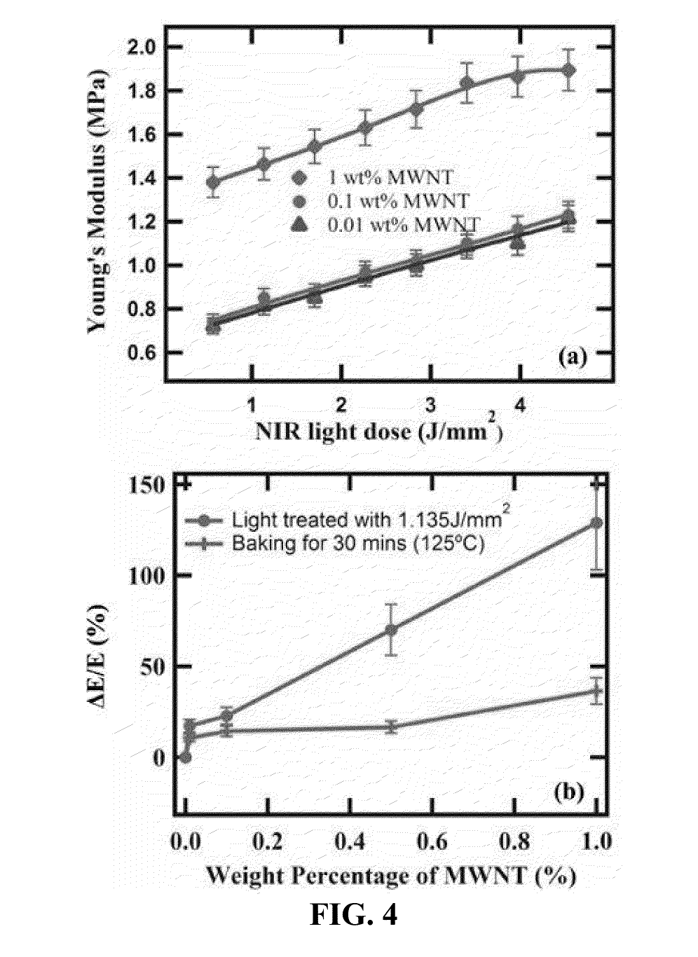

FIG. 4(a) presents the Young's modulus as a function of NIR energy dose with increasing fraction of MWNT in polymer composites. For small fractions (0.01-0.1 wt %) of MWNT in PDMS, there was only small change in elastic modulus values and both the curves looked similar. However, at approximately 1 wt % MWNT, the Young's modulus values increased roughly by twice for all the NIR dose energy levels, indicating that as the NIR dose was increased and, with more carbon nanotubes in the matrix, significant strengthening occurred, a phenomenon that could only happen if the nanotubes were heating the polymer and strengthening the interface.

FIG. 4(b) compares the change in elastic modulus as a percentage for both types of samples. The change in elastic modulus was calculated based on the elastic modulus of the pure PDMS for both the methods and calculating the percentage change based on increasing weight fractions of MWNT in the polymer sample. It was clear that for all wt % MWNT, the change in elastic modulus was higher for NIR treated samples compared to the oven polymerized samples. An approximately 36% increase in elastic modulus at 1 wt % MWNT was observed for oven polymerized samples versus an approximately 130% increase in elastic modulus for the same weight fraction of MWNT for NIR light polymerized samples. These results indicated that irradiating the sample with NIR light caused the nanotubes to heat inside the polymer thereby resulting in enhanced cross-linking and polymerization of the nanotube polymer interface that led to better mechanical properties and increased load transfer. The macroscopic temperature rise of the sample was measured to be approximately 75° C. for the NIR photon irradiated samples; however, the actual temperature rise at the nanotube/polymer interface was likely higher than that value to enable the observed increases in strength and load transfer.

In summary, the foregoing experiments demonstrated that photon-assisted heating of MWNT inside a polymer matrix resulted in dramatic enhancement in load transfer to the nanotube and a subsequent increase in the elastic modulus. Compared to the traditional convective polymerization techniques, the NIR method yielded an increase in elastic modulus values of approximately 130% for just 1 wt % MWNT in PDMS polymer, greater than most reported to date. Raman spectroscopy also indicated a shift in wavenumbers of approximately 20 cm⁻¹ for an approximately 80% strain, which is larger than most reported values in the past. Together, these results indicated that NIR light-induced heating of carbon nanotubes in the mixtures resulted in enhanced cross-linking and polymerization, as well as a higher load transfer and elastic modulus of the produced nanocomposite materials.

### Example 2

This Example describes the load transfer and mechanical properties of graphene/polymer composites. Raman spectroscopy was used to characterize the composites since it can be a powerful tool for understanding the interfacial load transfer in carbon fibers and carbon nanostructure fillers such as carbon nanotubes in polymer composites. The disorder-induced 2D bands and tangential mode G bands can be sensitive to both the compressive and tensile strains in carbon nanostructure fillers such as carbon nanotubes. The Raman stress sensitivity can arise from the anharmonicity of the atomic bonds. By using the interatomic potentials of the harmonic bond model and including the attractive and repulsive contributions (Mie and Gruneisen parameters), a direct relationship has been demonstrated between the wavenumber shift in the Raman bands and the bond deformation that can be expressed mathematically as:

$$\overline{w} = {\overline{w}}_{0} [ 1 - ( \frac{a + r + 3}{2} ) \times {ɛ}_{L} ]$$

where a and r are positive constants depending on the bond type and ∈_{L} is the applied strain. Therefore, strain induced Raman band shifts can be used to measure the change in the interatomic distances or the bond deformation due to the load transferred from the polymer to the graphene fillers. The ultimate mechanical properties of the composites can depend on the extent to which the load is transferred from the polymer to the graphene filler, and the graphene/polymer interface can play a role in the efficient stress transfer. Therefore, a large shift in Raman wavenumbers can signal high stress transfer from the polymer to the graphene fillers. This relationship can be mathematically expressed using the following equation:

$$Δσ = {E}_{f} {ɛ}_{L} = - \frac{{E}_{f} \cdot Δ \overline{w}}{R ( a , r )} ,$$

where E_{f} is the Young's modulus of the filler material and Δw the wavenumber shift. Thus, if the filler has the same bond type, and assuming that the applied strain field is constant throughout the composite matrix, a larger Raman wavenumber shift indicates a higher load transfer.

Reduced graphene oxide (RGO) and graphene nano platelet (GNP) based polymer composites were fabricated using in situ NIR photon-assisted heating of graphene and polymerization of the graphene/PDMS interface. The experiments focused on two types of graphene with differences in the number of layers to investigate how the number of layers might affect the mechanical properties of the composites. Homogenous dispersion of graphene (1 wt. % of RGO and GNP for comparison) in PDMS was prepared using a shear mixing process. Samples containing 1 wt. % RGO or GNP in PDMS were synthesized by both conventional baking method and NIR photon-assisted method, and those samples are studied and tested by SEM, Raman, and mechanical test system.

In conventional oven curing, samples were heated in a vacuum oven at 125° C. for 30 min following addition of cross-linkers and degasing. At this time and temperatures, the elastic modulus values saturate, indicating the end of the crosslinking process. Samples prepared by irradiation of NIR photons on the samples in situ following addition of cross-linkers and degasing resulted in the heating of the graphene/polymer interface to high temperatures.

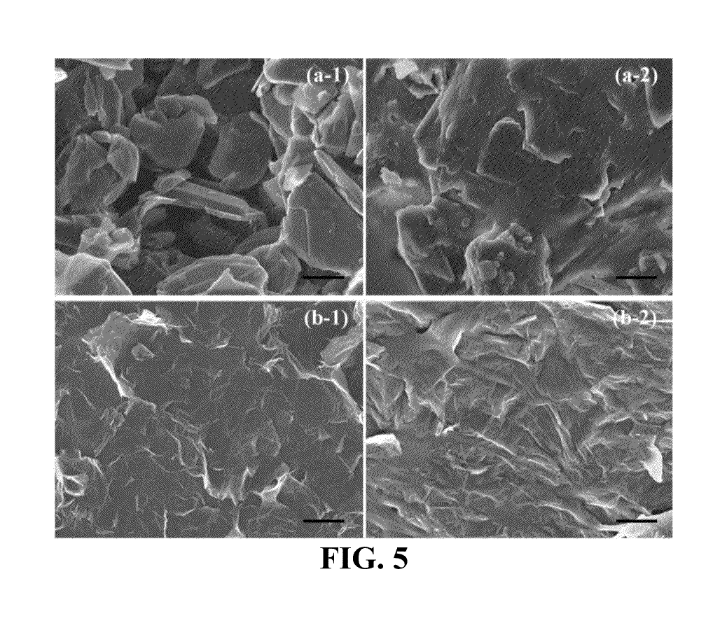

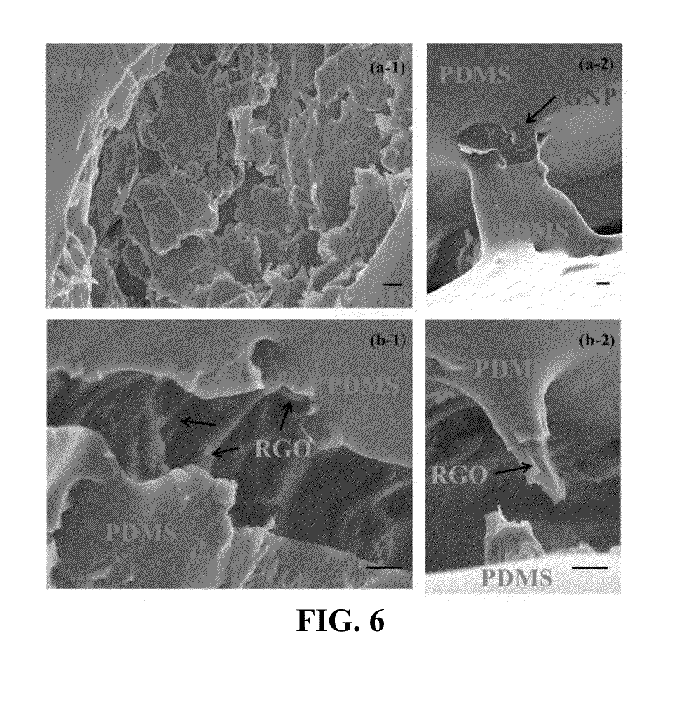

As shown in FIG. 5, GNPs showed a rigid stack/plate like morphology (FIG. 5(a-1) and FIG. 5(a-2)) while RGO demonstrated morphology of thin ribbon but with excellent dispersion (FIG. 5(b-1) and FIG. 5(b-2)). FIG. 6(a-1) and FIG. 6(a-2) present the fracture surface of GNP/PDMS, and FIG. 6(b-1) and FIG. 6(b-2) present the fracture surface of RGO/PDMS samples to investigate the microscopic morphology of load transfer. From the morphology of FIG. 6(a-1), it appeared that GNP fillers were pulled out of the PDMS matrix and fell onto the crater surface due to lack of flexibility. This is contrasted by other areas where GNP/PDMS bridged gaps between the cracks (FIG. 6(a-2)). These images suggested that GNPs acts as a reinforcement by, for example, bridging cracks between the surfaces and aiding in load transfer. On the other hand, RGO in cracks of the RGO/PDMS sample showed that most RGO appeared similar to the polymeric composite and also bridged the crack opening (FIG. 6(b-1)).

With respect to the fracture surface from other areas, FIG. 6(b-2) presents the fractured filler inside the crack. The layers of polymer and RGO plates are seen distinctly with the polymer pulled out of the RGO filler before complete failure of the filler. On the other hand, nanotubes tend to slide between bundles more easily than RGO fillers, as seen in the SEM images.

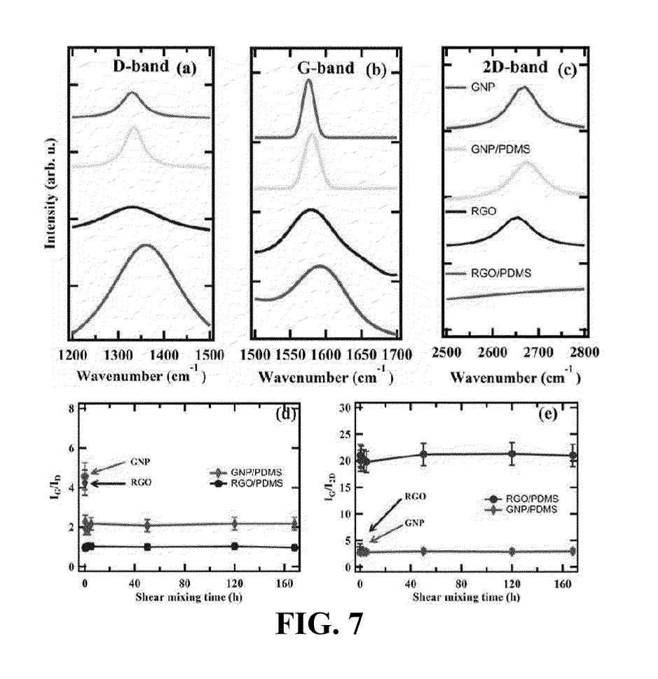

FIG. 7 presents the evolution of the Raman D, G, and 2D bands for pure GNP, pure RGO, and polymeric composites thereof as a function of the mixing process. The multilayer configuration of GNPs can cause a frequency shift in both peaks as compared to RGO. From the Raman bands, both G band (FIG. 7(b)) and the 2D band ratios (FIG. 7(c)) did not change significantly for GNP and GNP/PDMS samples. Comparing RGO and RGO/PDMS samples, however, the 2D band decreased (FIG. 7(c)) in intensity and the D band intensity increased (FIG. 7(a)). Without being bound by theory or mechanism, the change in D and 2D band intensities may be caused by damage of the RGO due to shear mixing, doping of RGO by the polymer, and functionalization of RGO sheets by the polymer. In order to ascertain whether the change in Raman D and 2D band intensity was result of mechanical damage over 7 days of shear mixing or doping and functionalization, the ratio of I_{G}/I_{D} and I_{G}/I_{2D} was measured at different intervals of mixing time.

FIG. 7(d) and FIG. 7(e) present the I_{G}/I_{D} and I_{G}/I_{2D} as a function of mixing time from 5 minutes to 168 hours. Within 5 minutes of mixing, the ratio reached a value that remained approximately constant for at least up to 160 hours. As a comparison, the ratio of I_{G}/I_{D} for pure RGO and GNP flakes are marked in FIG. 7(d) and FIG. 7(e). Mechanical damage due to shear mixing can demonstrate progressive increase in D band intensity due to increased number of defects between shorter and longer intervals of time, which were not observed in FIG. 7(d) and FIG. 7(e). The instantaneous change in I_{G}/I_{D} and I_{G}/I_{2D} can be due to doping and functionalization of graphene sheets. The ratio of 2D to G band intensities (I_{2D}/I_{G}) is a sensitive probe to monitor the effects of electron-donor and electron-acceptor molecules on electronic properties of graphene. Electron-donors decrease the (I_{2D}/I_{G}) ratio while electron-acceptor molecules increase this ratio. The ratio of I_{D}/I_{G} showed an opposite trend for the RGO/PDMS sample, suggesting that as D band intensity increases, 2D band decreases. Similarly, broadening of 2D bands and an increase in D band intensities can signify high functionalization densities of the polymer.

TABLE 1
Raman wavenumbers of D, G and 2D bands and their FWHM

| | D-band | FWHM-D | G-band | FWHM-G | 2D-band | FWHM-2D | | |
|---|---|---|---|---|---|---|---|---|
| | (cm⁻¹) | (cm⁻¹) | (cm⁻¹) | (cm⁻¹) | (cm⁻¹) | (cm⁻¹) | I_{G}/I_{D} | I_{G}/I_{2D} |
| GNP | 1330.5 | 59.09 | 1575.8 | 18.27 | 2666.9 | 74.13 | 4.57 | 2.65 |
| GNP/PDMS-Baking | 1333.3 | 61.26 | 1580.1 | 24.38 | 2673.7 | 76.56 | 2.17 | 2.96 |
| GNP/PDMS-NIR | 1334.3 | 59.62 | 1580.4 | 19.35 | 2674.5 | 74.99 | 2.61 | 3.10 |
| SLG | 1336.1 | 195.25 | 1568.3 | 28.37 | 2654.6 | 84.97 | 4.24 | 3.80 |
| SLG/PDMS-Baking | 1351.6 | 222.48 | 1592.8 | 88.31 | 2673.7 | 726.72 | 0.96 | 21 |
| SLG/PDMS-NIR | 1352.5 | 216.26 | 1593.6 | 85.32 | 2675.1 | 722.18 | 0.98 | 27 |

Table 1 presents the I_{D}/I_{G} ratio and I_{2D}/I_{G} ratios for all samples tested. This table presents evolution of Raman bands both in pure and mixed polymer composites, suggesting both doping and functionalization due to charge injection from the polymer as evidenced by the decrease in I_{2D}/I_{G} for the RGO samples. Charge injection as a function of pressure was quantified using Raman spectroscopy, and showed a decrease in I_{2D}/I_{G} values in alcohol compared to argon with increase in pressure from 0-7 GPa of RGO and BLG samples on SiO₂ substrates, which can suggest doping of the samples. Since the present samples were analyzed at ambient pressure, the doping and functionalization can be a result of the mixing process of the polymer interacting with the RGO defective sites. Mixing induced folding can result in unique D band and folds can appear as defective sites that can scatter phonons.

All these observations show that mixing graphene in polymer, such as PDMS, can result in charge injection even at ambient pressure as well as doping and functionalization. For instance, the source of the charge injection may be due to the reactive linkers in PDMS, namely silanol (Si—O—H) groups or from the methyl or ethyl groups from the side chains that have been used to link molecules to the Si—O backbones, and the charge injection from the silanol groups can result in screening of charges at a nanotube/SiO₂/ambient interface.

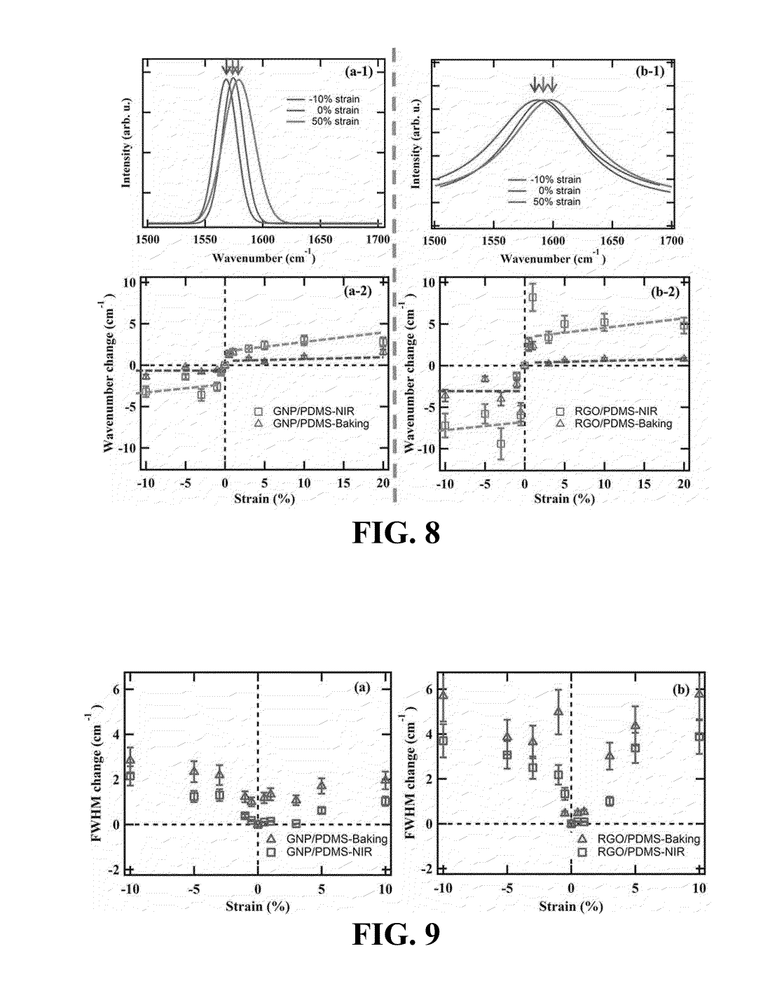

Furthermore, FIG. 8(a-1) and FIG. 8(b-1) present the shift in G band for GNP and RGO respectively. On application of ˜10% compressive strain, the G band shifted to the left, signaling lattice tension. Similarly, on application of 50% tensile strain, the G-band shifted right or increased in wavenumbers, suggesting lattice compression. These results are also true for RGO/PDMS samples. FIG. 8(a-2) and FIG. 8(b-2) present the Raman wave number change as a function of strain for GNP/PDMS and RGO/PDMS samples. As presented in both the figures, the conventional oven baked samples in both GNP/PDMS and RGO/PDMS resulted in lower Raman wave number change or less load transfer on application of strain. The NIR polymerization samples produced higher change in Raman wave numbers, demonstrating enhanced load transfer from polymer to the filler. Since the SEM and Raman signatures of the G band look similar for both baking and NIR polymerization, characterizing wavenumber shift in G peak in both samples upon application of strain was a measure of the graphene/polymer interfacial strength. The results showed that the RGO/PDMS sample polymerized using the NIR irradiative technique exhibited higher interfacial strength compared to the GNP counterparts. The change in Raman wavenumbers saturated at ˜10-12 cm⁻¹ after 20% strain in both GNP and RGO counterparts, and strains were no longer resolvable above 20% strain. The Raman signal can be related to the number of graphene/polymer sites or the weight fraction of the graphene in polymer matrix.

For GNP/PDMS composites, rate of peak shift with strain was ˜2.4 cm⁻¹/% strain in tension and ˜1.2 cm⁻¹/% strain under compression. The 2D band shifts were also quantified to be ˜0.8 cm⁻¹/% strain under tension and ˜0.7 cm⁻¹/% strain under compression, which was smaller than G band but demonstrated use of 2D band shift in GNP fillers for measuring load transfer. On the contrary, the 2D bands were sensitive to strains in carbon nanotubes, where 6 cm⁻¹/% was witnessed in tension using the same process conditions. Based on the G-band Raman shift, the interfacial stress was calculated to be ˜80 GPa for the GNP/polymer interface in compression. For RGO/PDMS, rate of G-peak shift with strain was ˜4.4 cm⁻¹/% strain in tension and ˜11.2 cm⁻¹/% strain in compression, suggesting enhanced load transfer in compression in bulk. The interfacial stress was calculated to be ˜410 GPa for RGO interface, suggesting fivefold increase in stress transfer in compression. For tension, the load transfer of RGO polymer interface was calculated to be ˜3.5 times that of GNP interface. This also suggest greater load transfer of RGO compared to single wall nanotube fillers in tension. Enhanced load transfer was witnessed for RGO fillers in both tension and compression compared to GNP fillers (FIG. 8). Such Raman shifts suggest bond deformation, minimum slippage that originates only from intimate contact of the RGO with the polymer, and better dispersion through long mixing. On the other hand, nanotube composites have demonstrated large Raman peak shift (15 cm⁻¹ of 2D band) in compression and small peak shift in tension.

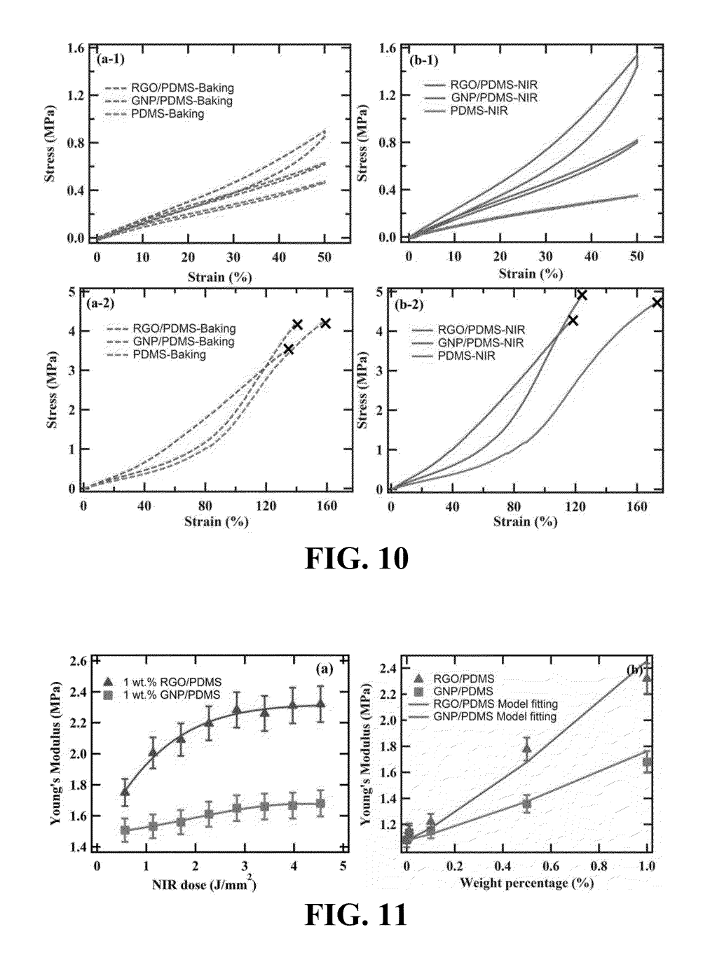

Further still, the full width half maximum (FWHM) of the wavenumbers were plotted against strain to investigate the extent of slippage in graphene/polymer composites. Depending on the morphology and the number of layers, RGO can slip less compared to rigid, stack-like GNP. FIG. 9(a) and FIG. 9(b) present the FWHM data for GNP and RGO graphene as well as both types of polymerization. Both RGO and GNP graphene/polymer composites underwent slippage in the polymer matrix similar to carbon nanotubes. For the oven based baking method, GNPs underwent greater slippage compared to the RGO counterparts. Without being bound by theory or mechanism, this can be explained from the rigid plate like morphology of GNPs in polymers, which can act as discrete rigid plates that do not interact with the polymer. FWHM data in compression show almost 15 cm⁻¹ for 10% compression. The sign of the FWHM also changed upon changing the compression, suggesting discrete movement of GNPs in the polymer matrix or slippage. However, the SEM images for RGO showed a continuous matrix, possibly due to the fact that RGO's one carbon layer can weave itself with the polymer creating a continuous matrix. This resulted in better dispersion and higher change in Raman wavenumbers upon application of strain for both of the fabrication methods. The higher integration of RGO also may have caused minimal slippage both in tension and compression for the oven baked samples. For the NIR treated method, there is a difference in the GNP based polymer composites. The NIR treated method resulted in little to no slippage of the GNP in the polymer matrix, and the FWHM data was almost zero for both compression and tension. It thus appears that the NIR irradiation heated the fillers all over the matrix and may have resulted in shorter segmental chain lengths of the polymer. Similarly, FIG. 9(b) for the RGO composite sample shows minimum slippage for the NIR treated method compared to the oven baked method, which may again be due to the morphology of the RGO weaving itself in the polymer matrix and thereby achieving enhanced dispersion and integration for both polymerization methods.

FIG. 10(a-1) and FIG. 10(b-1) present the cyclic stress-strain curves of PDMS, GNP/PDMS, and RGO/PDMS samples polymerized by conventional oven and NIR photon-assisted methods. The area under the hysteresis curve represents energy loss during the loading and unloading cycles. The area under hysteresis curve was larger for NIR samples, indicating 1431% (RGO/PDMS) and 324% (GNP/PDMS) improvement in damping capability compared to pure PDMS. On the other hand, the area under the hysteresis loop for conventional baking samples showed about a 673% increase for RGO/PDMS and about a 139% increase for GNP/PDMS compared to pure PDMS. RGO/PDMS showed higher damping capability than GNP/PDMS using the same polymerization method. The large damping capability of RGO fillers demonstrated considerable interfacial slippage between the PDMS and fillers and high thermal conductivity.

FIG. 10(a-2) and FIG. 10(b-2) present the stress-strain curves of GNP/PDMS, RGO/PDMS and pure PDMS samples till failure under different conventional and NIR polymerization methods. As more strain was applied, the polymeric chains in PDMS were stretched out till final failure was seen at about 160%. RGO/PDMS samples exhibited a linear stress-strain curve with failure at about 120%. This suggested stiffening of the matrix with addition of RGO at these low weight percentages. The increase in elastic modulus for RGO/PDMS was about 42% while that of GNP/PDMS was about 32% using polymerizing by conventional baking (FIG. 10(a-2)). FIG. 10(b-2) shows that the increase in elastic modulus for RGO/PDMS was about 115% while that of GNP/PDMS was about 55% when using polymerization by the NIR photon-assisted method.

Also, for samples polymerized by NIR photon-assisted method, at 115% end point strain, RGO/PDMS was calculated as 2.20 MJ/m³, GNP/PDMS was calculated as 1.76 MJ/m³, and pure PDMS was calculated as 0.97 MJ/m³. The flexibility of RGO can result in energy absorption without failing resulting in increased toughness of the composite. Finally, energy density values were calculated as about 2.14 kJ/Kg for RGO/PDMS, about 1.68 kJ/Kg for GNP/PDMS, and about 0.91 kJ/Kg for pure PDMS. This suggested an increase in strain energy density of about 233% for RGO fillers in PDMS. The high surface area of RGO sheets can make an intimate interaction with the polymer due to increased adhesion, resulting in higher strain energy densities. In the elastic regime, these high densities can be recovered as useful mechanical work thereby making at least RGO attractive for realization of advanced composites.

FIG. 11(a) presents Young's modulus as a function of NIR energy dose with 1 wt. % RGO/PDMS and GNP/PDMS. For both graphene/PDMS composites, Young's modulus increased with increasing NIR dose. Young's modulus of RGO/PDMS was higher than the modulus of GNP/PDMS, possibly due to the higher surface area of RGO compared to the same weight percentage of GNP. FIG. 11(b) compares the change in elastic modulus as a percentage for RGO/PDMS and GNP/PDMS polymerized by NIR photon-assisted treatment. For all wt. % graphene, the change in elastic modulus was higher for RGO samples compared to GNP samples.

Table 2 presents the elastic modulus values and the change in elastic modulus with respect to the pristine polymer for each of the fabrication methods. The results indicate, among other things, that the graphene polymer composites were stiffer when prepared using NIR irradiation than when prepared by the conventional baking method.

TABLE 2
Elastic modulus and elastic modulus change of graphene/PDMS
composites prepared by different polymerization methods.

| Composite | Elastic modulus | Elastic |
|---|---|---|
| (1 wt. % nano-carbon/PDMS) | (MPa) | modulus change |
| Pure PDMS-Baking | 1.12 ± 0.02 | — |
| GNP/PDMS-Baking | 1.48 ± 0.02 | 32.14% |
| RGO/PDMS-Baking | 1.60 ± 0.03 | 42.86% |
| Pure PDMS-NIR | 1.08 ± 0.02 | — |
| GNP/PDMS-NIR | 1.68 ± 0.03 | 55.56% |
| RGO/PDMS-NIR | 2.32 ± 0.01 | 115.81% |

In summary, the foregoing experiments demonstrated that mixing graphene, such as RGO, in polymers can influence the polymer's G and 2D band. The ratio of I_{G}/I_{2D} went from 2.65 for GNP to about 3 for GNP/PDMS samples, while from 3.80 to about 25 for RGO/PDMS samples. Also, the G bands of pure fillers and post fabrication of GNP or SLG/PDMS samples were shifted, suggesting compressive loading on the filler lattice. Without being bound by theory or mechanism, it is believed that the out of plane vibration due to the polymer entanglement is coupled to the in plane vibration of the sp² carbon atoms, suggesting three dimensional entanglement of the polymer to the filler lattice. Furthermore, NIR based polymerization resulted in higher load transfer and mechanical strength for GNP and RGO based composites when compared to conventional oven polymerization.

### Example 3

This Example describes mechanisms of NIR light induced polymerization and how it affects the interface between carbon nanostructures and a polymeric material. Nanoscale materials (e.g., carbon nanostructures), such as carbon nanotubes, graphene, graphene oxide, and reduced graphene oxide can absorb near infra-red light and induce photothermal heating. Other mechanisms may also enhance interfacial shear strength and associated increases in mechanical properties. For example, carbon nanostructures such as RGO are known to have several chemical groups, such as carboxyl, hydroxyl, carbonyl, and other C—O groups, on their surface. Further, defects such as dangling bonds in graphene may also enhance interaction with the polymer.

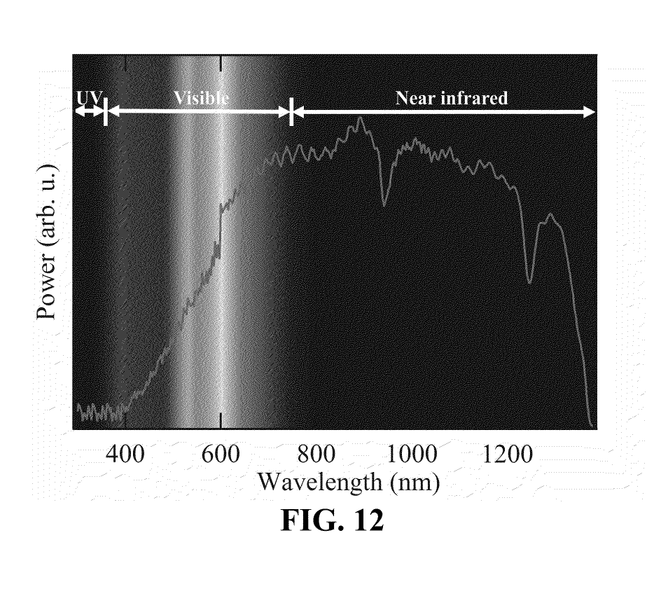

To form the samples, a homogenous dispersion of 1 wt. % multi-walled nanotubes (MWNT) and graphene (RGO or GNP for comparison) in PDMS was prepared. The XPS measurements were performed on a MultiLab 3000 VG Thermo Scientific (Waltham, Mass.) surface analysis system. Mg Kα (1253.6 eV) radiation was used as the excitation source and the measurements were performed at room temperature and under the ultra-high vacuum (UHV) condition with the pressure in the 10⁻⁹ Torr range. Charging of the samples was corrected by setting the binding energy of the adventitious carbon (C1s) at 284.6 eV. The PASS energy for scanning was set as 50 eV. Gaussian profile was used to fit the XPS peaks in XPSPEAK software. For each carbon nanostructure/PDMS composite, a set of five different samples were studied. An AQ-6315A optical spectrum analyzer (Ando; San Jose, Calif.) was used to measure the spectrum profile of the halogen lamp, an NIR light source. The spectral profile produced by Halogen lamp with UV filter is presented in FIG. 12. The halogen lamp showed high energy density in near infra-red range, including in the range between 650 nm to 1400 nm. The spectrum of the halogen lamp showed that it could be used as a NIR photon source to polymerize carbon nanostructure composites.

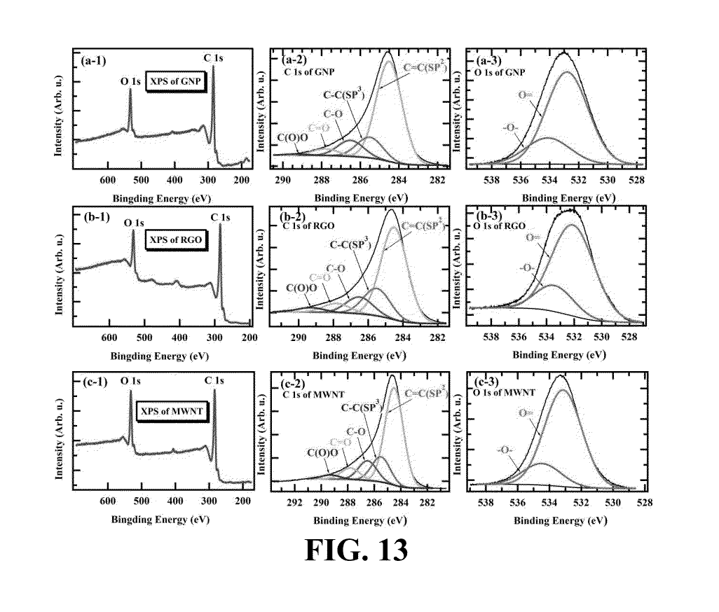

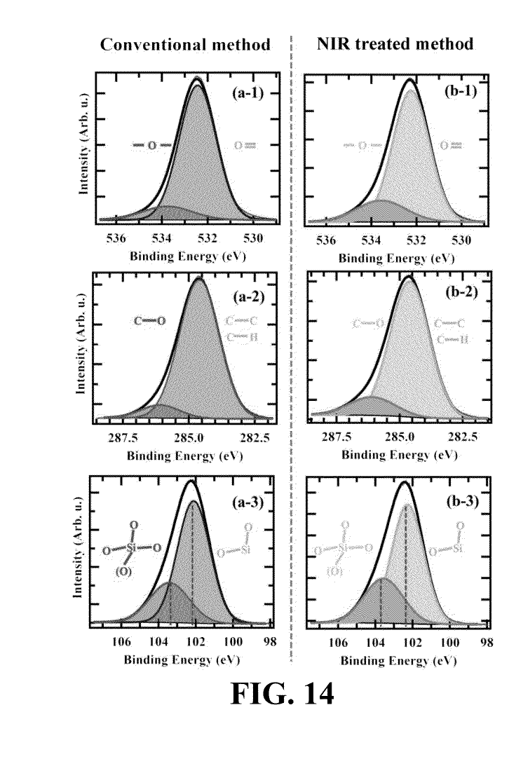

Using XPS, the MWNTs, GNPs and RGO was examined to characterize their surface chemical groups and morphology. The curve fittings of the C1s and O1s peaks were performed using Gaussian peak shapes for different carbon and oxygen bonding groups after performing the Shirley background correction. From FIG. 13 (a-2, b-2, c-2), the fitted ratio and binding energy for different carbon bonding groups were calculated and are summarized in Table 3. The binding energy of C1s was 284.5 eV for the C═C bond, 285.5 eV for the C—C bond, 286.5 eV for the C—O bond, 287.8 eV for the C═O bond, and 289.3 eV for the C(O)O bond. The highest percentage of the C—C (sp²) bond, about 69.2%, was found in GNP, compared to 61.7% in MWNT and 61.6% in RGO. A high percentage of the sp³ carbon, about 18.2%, was found in RGO, likely due to hydrogen reduction of the graphene oxide. The percentages of the C—O, C═O, and C(O)O bonds were higher in RGO and MWNTs than in GNP, which infers larger amounts of OH, COOH, and C═O in MWNT and RGO, indicating the existence of more functional groups.

TABLE 3
Fitted ratio and binding energy of carbon bonding groups in MWNT,
RGO, and GNP.

| Carbon | Binding energy (eV) | MWNT | RGO | GNP |
|---|---|---|---|---|
| C═C (sp²) | 284.5 | 61.7% | 61.6% | 69.2% |
| C—C (sp³) | 285.5 | 15.9% | 18.2% | 14.3% |
| C—O | 286.5 | 12.5% | 11.1% | 11.1% |
| C═O | 287.8 | 7.3% | 6.1% | 4.6% |
| C(O)O | 289.3 | 2.6% | 3.0% | 0.8% |

The information obtained by fitting the O1s peaks in FIG. 13(a-3, b-3, c-3) can complement the C1s peak data. Because the O1s peaks were surface specific due to the reduced kinetic energy and sampling depth, these values could be useful in assigning the carbonylic and carboxylic functional groups. MWNT, GNPs and RGO have similar defective groups like hydroxyl, epoxy (1,2-ether), carbonyl, and carboxyl groups on the surface.

FIG. 14(a-1, a-2, a-3) are graphs that plot the XPS peaks of O1s, C1s, and Si2p, respectively measured for the MWNT/PDMS composite synthesized by the conventional baking method. FIG. 14(b-1, b-2, b-3) plot the XPS peaks of O1s, C1s, and Si2p, respectively measured for the MWNT/PDMS composite synthesized by the NIR photon-assisted polymerization. The binding energies of O1s for the O═ and —O— atoms were 532.5 eV and 533.8 eV, respectively, which is in good agreement with previous work [192]. Comparing the O1s peaks in FIG. 14(a-1) and in FIG. 14(b-1), the NIR treated composite exhibited a higher percentage of the —O— bonding and a lower percentage of the O═ bonding than the conventionally baked composite. The oxygen double bond usually contains a weak p-bond and a strong σ-bond. Under NIR irradiation, this p-bond can be easily opened and thus can easily react with other atoms.

The C1s peaks were fitted by two sub-peaks, one corresponded to the carbon atoms connected with hydrogen or other carbon atoms including the sp² and sp^{a} bonds, and the other peak corresponded to the carbon atoms covalently bonded with oxygen atom, including the carbon atoms in hydroxyl, epoxy, carbonyl, and carboxylic groups. Comparing the C1s peaks in FIG. 14(a-2) and in FIG. 14(b-2) shows that the NIR treated composite possessed a higher percentage of carbons bonded with oxygen and a lower percentage of carbons with the C—C/C—H bonds than the conventionally baked composite. Thus, the NIR heat treatment can be more effective in oxidizing carbons. The oxygen atoms in PMDS connects with two silicon atoms, which have a high value of Gibbs free energy and are thus difficulty to react. By contrast, the oxygen atoms on the surface of the carbon nanostructures are much easier to react. The carbon-carbon double bond also has a weak p-bond and a strong σ-bond. Corresponding to the C1s XPS peaks, the oxygen atoms on the carbon nanostructures bond covalently with the carbon atoms on PDMS and are shown in the O1s XPS peaks.

FIG. 14(a-3) and FIG. 14(b-3) plot the Si2p peaks measured in the conventionally baked composite and the NIR treated composite, respectively. The Si2p peak of the NIR treated composite shifted by 0.15 eV to larger binding energies, possibly creating a higher average effective electrostatic force for the Si—O bonds in NIR treated composite [193]. Compared to the conventionally baked composite, the NIR treated composite also displayed a slightly higher percentage of silicons bonded with three or four oxygens. Overall, the trends in the O1s, C1s, and Si2p peaks show that the oxygen atoms on the carbon nanostructures are bonded with the carbon atoms and the Silicon atoms in PDMS.

Table 4 lists the ratios between the two different oxygen bonds, the ratios between the two different carbon bonds, and the ratios between different silicon bonds atoms for the MWNT/PDMS composites prepared by oven baking and by NIR heating. These ratios were obtained by fitting the O1s, C1s, and Si2p XPS peaks.

TABLE 4
Ratios between different oxygen bonds, different carbon bonds,
and different silicon bonds for MWNT/PDMS samples
prepared by baking and NIR polymerization.

| Area ratio | 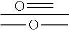 | 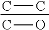 | 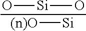 |
|---|---|---|---|
| MWNT/ | 7.4 ± 0.3 | 11.0 ± 0.3 | 2.5 ± 0.1 |
| PDMS- | | | |
| Baking | | | |
| MWNT/ | 4.5 ± 0.2 | 6.4 ± 0.2 | 2.2 ± 0.1 |
| PDMS- | | | |
| NIR | | | |

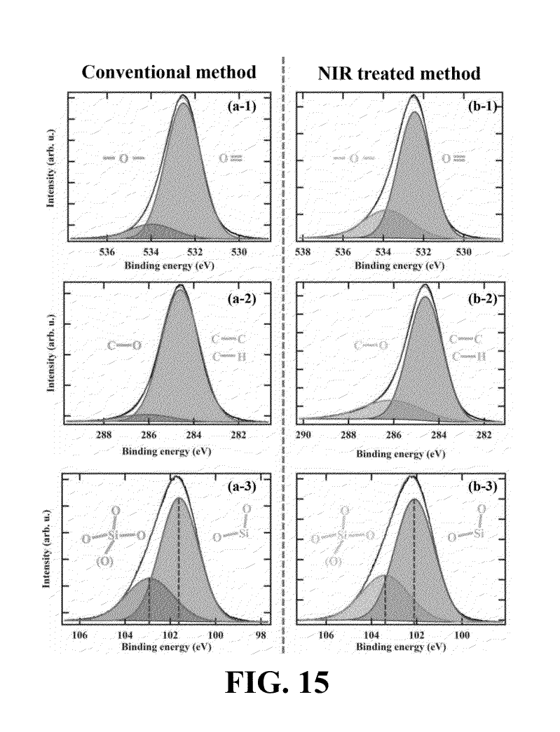

FIG. 15(a-1), FIG. 15(a-2), and FIG. 15(a-3) plot the XPS peaks of O1s, C1s, and Si2p for a RGO/PDMS composite synthesized by the conventional baking method. FIG. 15(b-1),FIG. 15(b-2), and FIG. 15(b-3) plot the XPS peaks of O1s, C1s, and Si2p for a RGO/PDMS composite synthesized by NIR photon-assisted polymerization. FIG. 15 displays the similar contrasts between the RGO/PDMS composites prepared by the two methods to those seen in FIG. 14.

Again, when compared to the conventionally baked RGO/PDMS composite, the NIR treated RGO/PDMS composite showed a higher percentage of the —O— bonding, a lower percentage of the O═ bonding, a higher percentage of carbons bonded with oxygen, a lower percentage of carbons with the C—C/C—H bonds, and a higher percentage of silicons bonded with three or four oxygens. The Si2p peak of the NIR treated RGO/PDMS composite shifted by 0.5 eV to larger binding energies compared to the conventionally baked RGO/PDMS composite. The GNP/PDMS composites showed lower percentages of oxygen groups. The NIR treated GNP/PDMS composite and the conventionally baked GNP/PDMS composite were measured to exhibit smaller contrast than MWNT/PDMS and RGO/PDMS.

TABLE 5
The ratios between different oxygen bonds, carbon bonds,
and t silicon bonds for RGO/PDMS and GNP/PDMS samples
prepared by baking and NIR polymerization.

| Area ratio | 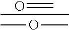 | 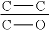 | 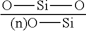 |
|---|---|---|---|
| RGO/ | 6.8 ± 0.6 | 10.6 ± 0.6 | 2.5 ± 0.1 |
| PDMS- | | | |
| Baking | | | |
| RGO/ | 3.0 ± 0.2 | 3.7 ± 0.3 | 2.1 ± 0.1 |
| PDMS- | | | |
| NIR | | | |
| GNP/ | 10.7 ± 0.3 | 7.6 ± 0.3 | 2.6 ± 0.1 |
| PDMS- | | | |
| Baking | | | |
| GNP/ | 10.1 ± 0.2 | 7.5 ± 0.1 | 2.4 ± 0.1 |
| PDMS- | | | |
| NIR | | | |

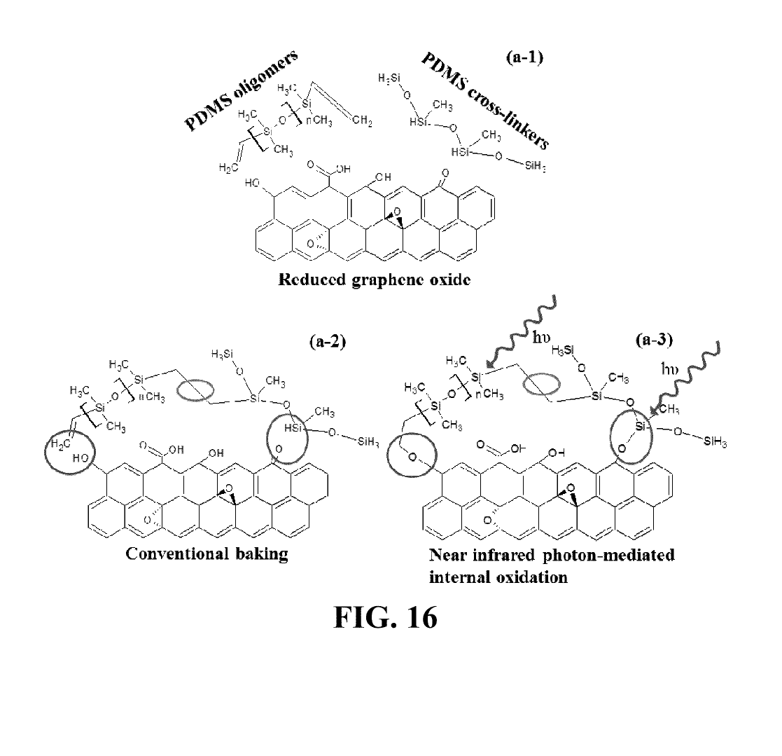

Table 5 lists the ratios between the two different oxygen bonds, the ratios between the two different carbon bonds, and the ratios between the different silicon bonds atoms for the RGO/PDMS and GNP/PDMS composites prepared by oven baking and by NIR heating. FIG. 16(a-1) depicts the chemical structures of the oligomers and the cross-linkers of PDMS and RGO. The epoxy, hydroxyl, carbonyl and carboxyl groups are shown on the surface of RGO. In FIG. 16(a-2), the center circle depicts the crosslink process between the PDMS oligomers and the PDMS crosslinker. The left circle and the right circle depict two reactions between PDMS and RGO during polymerization. FIG. 16(a-3) shows the model of near NIR photon-assisted polymerization. The crosslinking reaction depicted in the center circle still takes place due to the heat generated from the carbon nanostructures by photothermal heating, and macroscopic temperature increases of 70° C. were observed using photon assisted heating. Furthermore, the reaction in the left circle shows the p i-bond opened and connected with the hydroxyl group on the surface of RGO. As depicted in the right circle, the silicon atom of the SiH group, which also efficiently absorbs NIR light, reacts with the carbonyl group on the surface of RGO. Without being bound by theory or mechanism, these two reactions create new covalent bonds between the carbon atoms in PDMS and the oxygen atoms on RGO, thus strengthening the interface and enhancing the mechanical properties of the carbon nanostructure composites.

In summary, the foregoing experiments compared NIR polymerization and conventional baking polymerization using three different carbon nanostructures (MWNT, GNP, and RGO) to prepare the carbon nanostructure/polymer composites. XPS was used to analyze and compare the interfacial bond formation of the carbon nanostructure/polymer composites synthesized by both methods. It was found that the NIR treated composites contained more C—O, —O—, and Si—O bonds than the conventionally baked composites when all three types of nanocarbons were used as the fillers, indicating that more covalent bonds were formed between the carbon nanostructures and the polymer matrix in the NIR heating-assisted polymerization method, which also helped strengthen the carbon nanostructure/polymer interface.

These result are in agreement with the earlier Raman measurements having relatively smaller changes of FWHM for the Raman peaks and relatively larger shifts for the Raman peak positions for NIR treated composites. Further, the XPS studies showed a correlation between bond formation and overall improvement in mechanical properties, such as Young's modulus, strain energy density, toughness, and load transfer. The NIR light induced heating and oxidation, but can claim no interfacial damage to the carbon nanostructure during functionalization.

Throughout this document, various references are mentioned. All such references are incorporated herein by reference, including the references set forth in the following list:

### REFERENCES

1. H. D. Wagner, O. Lourie, Y. Feldman, and R. Tenne, “Stress-induced fragmentation of multiwall carbon nanotubes in a polymer matrix,” Applied Physics Letters, vol. 72, pp. 188-190, Jan. 12, 1998.
2. L. S. Schadler, S. C. Giannaris, and P. M. Ajayan, “Load transfer in carbon nanotube epoxy composites,” Applied Physics Letters, vol. 73, pp. 3842-3844, Dec. 28, 1998.
3. J. Zhu, J. D. Kim, H. Q. Peng, J. L. Margrave, V. N. Khabashesku, and E. V. Barrera, “Improving the dispersion and integration of single-walled carbon nanotubes in epoxy composites through functionalization,” Nano Letters, vol. 3, pp. 1107-1113, August 2003.
4. C. A. Mitchell, J. L. Bahr, S. Arepalli, J. M. Tour, and R. Krishnamoorti, “Dispersion of functionalized carbon nanotubes in polystyrene,” Macromolecules, vol. 35, pp. 8825-8830, Nov. 5, 2002.
5. R. Haggenmueller, F. M. Du, J. E. Fischer, and K. I. Winey, “Interfacial in situ polymerization of single wall carbon nanotube/nylon 6,6 nanocomposites,” Polymer, vol. 47, pp. 2381-2388, Mar. 22, 2006.
6. B. C. Satishkumar, A. Govindaraj, J. Mofokeng, G. N. Subbanna, and C. N. R. Rao, “Novel experiments with carbon nanotubes: Opening, filling, closing and functionalizing nanotubes,” Journal of Physics B—Atomic Molecular and Optical Physics, vol. 29, pp. 4925-4934, Nov. 14, 1996.
7. A. Kuznetsova, D. B. Mawhinney, V. Naumenko, J. T. Yates, J. Liu, and R. E. Smalley, “Enhancement of adsorption inside of single-walled nanotubes: opening the entry ports,” Chemical Physics Letters, vol. 321, pp. 292-296, Apr. 28, 2000.
8. C. A. Dyke and J. M. Tour, “Covalent functionalization of single-walled carbon nanotubes for materials applications,” Journal of Physical Chemistry A, vol. 108, pp. 11151-11159, Dec. 23, 2004.
9. F. M. Du, J. E. Fischer, and K. I. Winey, “Effect of nanotube alignment on percolation conductivity in carbon nanotube/polymer composites,” Physical Review B, vol. 72, September 2005.
10. Z. Jia and C. L. Xu, J.; Wei, B.; Wu, D.; Zhu, C, Xinxing Tan Cailiao, vol. 14, pp. 32-36, 1999.
11. Z. W. Jia, Z.; Xu, C.; and J. W. Liang, B.; Wu, D.; Zhang, Z., Qinghua Daxue Xuebao, Ziran Kexueban, vol. 40, pp. 14-16, 2000.
12. W. D. Zhang, L. Shen, I. Y. Phang, and T. X. Liu, “Carbon nanotubes reinforced nylon-6 composite prepared by simple melt-compounding,” Macromolecules, vol. 37, pp. 256-259, Jan. 27, 2004.
13. M. Moniruzzaman, J. Chattopadhyay, W. E. Billups, and K. I. Winey, “Tuning the mechanical properties of SWNT/Nylon 6,10 composites with flexible spacers at the interface,” Nano Letters, vol. 7, pp. 1178-1185, May 2007.
14. N. W. S. Kam, M. O'Connell, J. A. Wisdom, and H. J. Dai, “Carbon nanotubes as multifunctional biological transporters and near-infrared agents for selective cancer cell destruction,” Proceedings of the National Academy of Sciences of the United States of America, vol. 102, pp. 11600-11605, Aug. 16, 2005.
15. N. Shao, S. Lu, E. Wickstrom, and B. Panchapakesan, “Integrated molecular targeting of IGF1R and HER2 surface receptors and destruction of breast cancer cells using single wall carbon nanotubes,” Nanotechnology, vol. 18, Aug. 8, 2007.
16. N. H. Levi-Polyachenko, E. J. Merkel, B. T. Jones, D. L. Carroll, and J. H. Stewart, “Rapid Photothermal Intracellular Drug Delivery Using Multiwalled Carbon Nanotubes,” Molecular Pharmaceutics, vol. 6, pp. 1092-1099, July-August 2009.
17. S. X. Lu and B. Panchapakesan, “Optically driven nanotube actuators,” Nanotechnology, vol. 16, pp. 2548-2554, November 2005.
18. Y. Lu, D. B. Shao, and S. C. Chen, “Laser-assisted photothermal imprinting of nanocomposite,” Applied Physics Letters, vol. 85, pp. 1604-1606, Aug. 30, 2004.
19. J. Loomis, B. King, and B. Panchapakesan, “Layer dependent mechanical responses of graphene composites to near infrared light,” Applied Physics Letters, vol. 100, 2012.
20. J. Loomis, B. King, T. Burkhead, P. Xu, N. Bessler, E. Terentjev, and B. Panchapakesan, “Graphene-nanoplatelet-based photomechanical actuators,” Nanotechnology, vol. 23, Feb. 3, 2012.
21. Y. Gao, L. Y. Li, P. H. Tan, L. Q. Liu, and Z. Zhang, “Application of Raman spectroscopy in carbon nanotube-based polymer composites,” Chinese Science Bulletin, vol. 55, pp. 3978-3988, December 2010.
22. B. Vigolo, B. Vincent, J. Eschbach, P. Bourson, J. F. Mareche, E. Mcrae, A. Muller, A. Soldatov, J. M. Hiver, A. Dahoun, and D. Rouxel, “Multiscale Characterization of Single-Walled Carbon Nanotube/Polymer Composites by Coupling Raman and Brillouin Spectroscopy,” Journal of Physical Chemistry C, vol. 113, pp. 17648-17654, Oct. 15, 2009.
23. A. de la Vega, J. Z. Kovacs, W. Bauhofer, and K. Schulte, “Combined Raman and dielectric spectroscopy on the curing behaviour and stress build up of carbon nanotube-epoxy composites,” Composites Science and Technology, vol. 69, pp. 1540-1546, August 2009.
24. J. Bult, R. Duncan, P. M. Ajayan, and L. S. Schadler, “Evaluation of interfacial load transfer in carbon nanotube composites using polarized Raman spectroscopy,” Abstracts of Papers of the American Chemical Society, vol. 237, Mar. 22, 2009.
25. S. Lefrant, M. Baibarac, and I. Baltog, “Raman and FTIR spectroscopy as valuable tools for the characterization of polymer and carbon nanotube based composites,” Journal of Materials Chemistry, vol. 19, pp. 5690-5704, 2009.
26. S. Singamaneni, V. Shevchenko, and V. Bliznyuk, “Unusual ignition behavior of polyurethane/carbon nanotube composites with a He—Ne laser excitation (632.8 nm) during micro-Raman spectroscopy,” Carbon, vol. 44, pp. 2191-2195, September 2006.
27. H. Kuzmany, R. Pfeiffer, M. Hulman, and C. Kramberger, “Raman spectroscopy of fullerenes and fullerene-nanotube composites,” Philosophical Transactions of the Royal Society of London Series a—Mathematical Physical and Engineering Sciences, vol. 362, pp. 2375-2406, Nov. 15, 2004.
28. Q. Zhao and H. D. Wagner, “Raman spectroscopy of carbon-nanotube-based composites,” Philosophical Transactions of the Royal Society of London Series a—Mathematical Physical and Engineering Sciences, vol. 362, pp. 2407-2424, Nov. 15, 2004.
29. O Lourie and H. D. Wagner, “Transmission electron microscopy observations of fracture of single-wall carbon nanotubes under axial tension,” Applied Physics Letters, vol. 73, pp. 3527-3529, Dec. 14, 1998.
30. S. L. Ruan, P. Gao, X. G. Yang, and T. X. Yu, “Toughening high performance ultrahigh molecular weight polyethylene using multiwalled carbon nanotubes,” Polymer, vol. 44, pp. 5643-5654, September 2003.
31. N. Lachman, C. Bartholome, P. Miaudet, M. Maugey, P. Poulin, and H. D. Wagner, “Raman Response of Carbon Nanotube/PVA Fibers under Strain,” Journal of Physical Chemistry C, vol. 113, pp. 4751-4754, Mar. 26, 2009.
32. Bae, S., H. Kim, Y. Lee, X. F. Xu, J. S. Park, Y. Zheng, J. Balakrishnan, T. Lei, H. R. Kim, Y. I. Song, Y. J. Kim, K. S. Kim, B. Ozyilmaz, J. H. Ahn, B. H. Hong, and S. Iijima, Roll-to-roll production of 30-inch graphene films for transparent electrodes. Nature Nanotechnology, 2010. 5(8): p. 574-578.
33. Treacy, M. M. J., T. W. Ebbesen, and J. M. Gibson, Exceptionally high Young's modulus observed for individual carbon nanotubes. Nature, 1996. 381(6584): p. 678-680.
34. Frank, I. W., D. M. Tanenbaum, A. M. Van der Zande, and P. L. McEuen, Mechanical properties of suspended graphene sheets. Journal of Vacuum Science & Technology B, 2007. 25(6): p. 2558-2561.
35. Shaffer, M. S. P. and A. H. Windle, Fabrication and Characterization of Carbon Nanotube/Poly(vinyl alcohol) Composites. Advanced Materials, 1999. 11(11): p. 937-941.
36. Cadek, M., J. N. Coleman, V. Barron, K. Hedicke, and W. J. Blau, Morphological and mechanical properties of carbon-nanotube-reinforced semicrystalline and amorphous polymer composites. Applied Physics Letters, 2002. 81(27): p. 5123-5125.
37. Wang, J., H. Hu, X. Wang, C. Xu, M. Zhang, and X. Shang, Preparation and mechanical and electrical properties of graphene nanosheets—poly(methyl methacrylate) nanocomposites via in situ suspension polymerization. Journal of Applied Polymer Science, 2011. 122(3): p. 1866-1871.
38. Xie, S. H., Y. Y. Liu, and J. Y. Li, Comparison of the effective conductivity between composites reinforced by graphene nanosheets and carbon nanotubes. Applied Physics Letters, 2008. 92(24): p. 243121-3.
39. Chen, Z., W. Ren, L. Gao, B. Liu, S. Pei, and H.-M. Cheng, Three-dimensional flexible and conductive interconnected graphene networks grown by chemical vapour deposition. Nature Materials, 2011. 10(6): p. 424-428.
40. Fang, M., K. Wang, H. Lu, Y. Yang, and S. Nutt, Covalent polymer functionalization of graphene nanosheets and mechanical properties of composites. Journal of Materials Chemistry, 2009. 19(38): p. 7098-7105.
41. Huang, C., H. Bai, C. Li, and G. Shi, A graphene oxide/hemoglobin composite hydrogel for enzymatic catalysis in organic solvents. Chemical Communications, 2011. 47(17): p. 4962-4964.
42. Jorio, A., Raman Spectroscopy in Graphene-Based Systems: Prototypes for Nanoscience and Nanometrology. ISRN Nanotechnology, 2012. 2012: p. 16.
43. Ferraro, J. R., K. Nakamoto, and C. W. Brown, Introductory Raman Spectroscopy 2003: Elsevier.
44. Gouadec, G. and P. Colomban, Raman Spectroscopy of nanomaterials: How spectra relate to disorder, particle size and mechanical properties. Progress in Crystal Growth and Characterization of Materials, 2007. 53(1): p. 1-56.
45. Malard, L. M., M. A. Pimenta, G. Dresselhaus, and M. S. Dresselhaus, Raman spectroscopy in graphene. Physics Reports, 2009. 473(5-6): p. 51-87.
46. Xu, P., J. Loomis, and B. Panchapakesan, Photo-thermal polymerization of nanotube/polymer composites: Effects of load transfer and mechanical strength. Applied Physics Letters, 2012. 100(13).
47. Kalaitzidou, K., H. Fukushima, and L. T. Drzal, Mechanical properties and morphological characterization of exfoliated graphite—polypropylene nanocomposites. Composites Part A: Applied Science and Manufacturing, 2007. 38(7): p. 1675-1682.
48. Zhang, J. and Z. Qiu, Morphology, Crystallization Behavior, and Dynamic Mechanical Properties of Biodegradable Poly(∈-caprolactone)/Thermally Reduced Graphene Nanocomposites. Industrial & Engineering Chemistry Research, 2011. 50(24): p. 13885-13891.
49. Ajayan, P. M., L. S. Schadler, C. Giannaris, and A. Rubio, Single-walled carbon nanotube-polymer composites: Strength and weakness. Advanced Materials, 2000. 12(10): p. 750-+.
50. Ferrari, A. C., Raman spectroscopy of graphene and graphite: Disorder, electron-phonon coupling, doping and nonadiabatic effects. Solid State Communications, 2007. 143(1-2): p. 47-57.
51. Rao, C. N. R., K. Biswas, K. S. Subrahmanyam, and A. Govindaraj, Graphene, the new nanocarbon. Journal of Materials Chemistry, 2009. 19(17): p. 2457-2469.

One of ordinary skill in the art will recognize that additional embodiments are also possible without departing from the teachings of the presently-disclosed subject matter. This detailed description, and particularly the specific details of the exemplary embodiments disclosed herein, is given primarily for clarity of understanding, and no unnecessary limitations are to understood therefrom, for modifications will become apparent to those skilled in the art upon reading this disclosure and may be made without departing from the spirit or scope of the presently-disclosed subject matter.

What is claimed is:

1. A method for fabricating a polymer composite, comprising the steps of:
providing a mixture including carbon nanostructures and a polymeric material; and
photo-thermally heating the mixture to thereby cross-link the carbon nanostructures and the polymeric material.

2. The method of claim 1, wherein the step of photo-thermally heating the mixture includes heating the mixture from an interface of the carbon nanostructures and the polymeric material to an exterior surface of the mixture.

3. The method of claim 1, wherein the step of photo-thermally heating the mixture includes exposing the mixture to near infrared radiation.

4. The method of claim 3, wherein the near infrared radiation has wavelengths of about 650 nm to about 1400 nm.

5. The method of claim 1, wherein the step of photo-thermally heating the mixture includes exposing the mixture to electromagnetic radiation for about 20 minutes to about 240 minutes.

6. The method of claim 5, wherein the electromagnetic radiation includes near infrared radiation.

7. The method of claim 1, wherein the carbon nanostructures are selected from the group consisting of carbon nanotubes, buckyballs, graphene, or combinations thereof.

8. The method of claim 1, wherein the carbon nanostructures include multi-wall carbon nanotubes.

9. The method of claim 1, wherein the carbon nanostructures comprise reduced graphene oxide, graphene nanoplatelets, or combinations thereof.

10. The method of claim 1, wherein the mixture includes about 0.01 to about 1 percent by weight of the carbon nanostructures.

11. The method of claim 1, wherein the polymeric material is selected from a plastic material or a rubber material.

12. The method of claim 1, wherein the polymeric material is polydimethyl siloxane.

13. The method of claim 1, further comprising the step of adding one or more cross-linking agents to the mixture prior to photo-thermally heating the mixture.

14. The method of claim 13, wherein a ratio of the one or more cross-linking agents to the polymeric material is about 1:10.

15. The method of claim 1, further comprising the step of degassing the mixture prior to photo-thermally heating the mixture.

16. The method of claim 1, wherein the step of providing a mixture includes mixing the mixture including the carbon nanostructures and the polymeric material for about 5 minutes to about 160 hours.

17. A method for fabricating a polymer composite, comprising:
mixing carbon nanostructures and a polymeric material to form a mixture; and
exposing the mixture to near infrared radiation to photo-thermally heat the mixture from an interface of the carbon nanostructures and the polymeric material to an exterior surface of the mixture and thereby cross-link the carbon nanostructures and the polymeric material into a polymer composite.

18. The method of claim 17, wherein the near infrared radiation has wavelengths of about 650 nm to about 1400 nm.

19. A polymer composite fabricated by a process comprising the steps of:
providing a mixture including carbon nanostructures and a polymeric material; and
photo-thermally heating the mixture to thereby cross-link the carbon nanostructures and the polymeric material.

20. The polymer composite of claim 19, wherein the polymer composite comprises an elastic modulus of about 0.5 MPa to about 1 GPa.

21. The polymer composite of claim 19, wherein the polymer composite comprises an elastic modulus of about 1.65 MPa to about 2.33 MPa.

22. The polymer composite of claim 19, wherein the carbon nanostructures are selected from the group consisting of carbon nanotubes, buckyballs, graphene, or combinations thereof.

23. The polymer composite of claim 19, wherein the carbon nanostructures comprise reduced graphene oxide, graphene nanoplatelets, or combinations thereof.

24. The polymer composite of claim 19, wherein the mixture includes about 0.01 to about 1 percent by weight of the carbon nanostructures.
